(19) United States
(12) Patent Application Publication
(10) Pub. No.: US 2023/0086454 A1
(43) Pub. Date: Mar. 23, 2023

(54) SYSTEM AND METHOD FOR MICRO-CODED SEARCHING PLATFORM

(71) Applicant: SRAX, Inc., Westlake Village, CA (US)

(72) Inventor: Christopher O'Neil, Westlake Village, CA (US)

(73) Assignee: SRAX, Inc., Westlake Village, CA (US)

(21) Appl. No.: 17/580,546

(22) Filed: Jan. 20, 2022

Related U.S. Application Data
(60) Provisional application No. 63/245,440, filed on Sep. 17, 2021.

(51) Int. Cl. G06F 16/242; G06F 16/2457; G06F 16/2455; G06F 9/22

(52) U.S. Cl. CPC G06F 16/2425; G06F 16/24578; G06F 16/24558; G06F 9/22

(57) ABSTRACT

Systems and methods are described that provide a backend micro-code architecture and a front-end user agent. For example, the user agent may accept an instruction that contains one or more components of an opcode. The backend system may receive the instruction and provide it to a bifurcated process. The first part of the process can decode the instruction and execute a series of search queries that correspond with the instruction. The second part of the process can receive the search results, create a data model/script that can be read by the user agent, and return/embed the data model/script to the user agent. The user agent may search the data model locally at the user device to reduce the number of electronic communications between the backend and front-end. The user agent can enable the user to dynamically create a new search by selecting different combination of the five components of an opcode.

### CROSS-REFERENCE TO RELATED APPLICATIONS

This application claims the benefit of U.S. Provisional Application No. 63/245,440 filed Sep. 17, 2021, which is hereby incorporated herein by reference in its entirety.

### TECHNICAL FIELD

The present disclosure relates generally to web searches and in particular, some implementations may relate to computational actions relating to shelf forecasting.

### DESCRIPTION OF RELATED ART

Web searches are prevalent in daily life. Standard web searches return search results in response to a search query provided by a user. More complex searches require multiple search queries that are changed by a user to dynamically redefine the search query based on the results of previous queries to achieve their goal. Better methods are needed.

### BRIEF SUMMARY OF THE DISCLOSURE

Systems, methods, and computer readable media are disclosed for a micro-coded searching platform. For example, the platform may include a backend micro-code architecture and a front-end user agent. The user agent may determine a search instruction that contains one or more components of an opcode, including an option, a query, a filter, a model, and a pointer. The backend system may receive the instruction and provide it to a bifurcated process. The first part of the process can decode the instruction and execute a set of search queries that correspond with the instruction. The second part of the process can receive the search results, create a data model/script that can be read by the user agent, and return/embed the data model/script to the user agent. The user agent may be enabled to search the data model locally at the user device to reduce the number of electronic communications between the backend and front-end. The user agent can enable the user to dynamically create a new search by selecting a different combination of the five components of the opcode. The format for displaying the data may be based on a stored user profile.

This disclosure may enable rapid and efficient development of queries in the context of web information. To enable this functionality, in some embodiments, an additional layer is added to the search engine computational technology stack. Traditional systems may use an open source Apache® as the oldest and the first layer of the technology stack to standardize the information retrieval concepts. For example, an inverted index (e.g., a database index) may store a mapping from content, such as words or numbers, to its locations in a document. In practice, this query language is complicated and only a few are expert enough in the art of information retrieval to apply the query language. In some embodiments of the disclosure, a second layer may be introduced to create an intermediate query language (e.g., using opcodes, special variables, tokens, embedded tags, etc.) to simplify the query formation.

In some embodiments, the second layer may be augmented with additional functionality locally, using an open source searching platform (e.g., Elasticsearch® Service and Apache Solr®, or as an external service. The second layer may be separated from the web application support functionality and efficiencies (e.g., dynamic queries, dynamic query scheduling, concurrent execution). In some examples, the second layer may enable machine learning to automatically create new arrangements. This disclosure may provide additional detail to incorporate opcodes and a compiler. Depending on the native functionality of the second layer, the opcodes can be applied directly to the second layer or the opcodes are applied as an additional third layer. The standard compiler design may seamlessly address either case. The illustrations contained in this patent apply the opcodes to the second layer even though additional implementations are enabled as well.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a micro coding system, in accordance with the embodiments disclosed herein.

FIG. 2 illustrates components of an opcode, in accordance with the embodiments disclosed herein.

FIG. 3 illustrates the micro coding system with the bifurcated process, in accordance with the embodiments disclosed herein.

FIG. 4 illustrates a compiler process with scheduler, in accordance with the embodiments disclosed herein.

FIG. 5 illustrates a first pass compiler, in accordance with the embodiments disclosed herein.

FIG. 6 illustrates searching using an instruction linked list, in accordance with the embodiments disclosed herein.

FIG. 7 illustrates a multi-pass compiler process, in accordance with the embodiments disclosed herein.

FIG. 8 illustrates a builder process for examining individual processes, in accordance with the embodiments disclosed herein.

FIG. 9 illustrates a user agent, in accordance with the embodiments disclosed herein.

FIG. 10 illustrates a process for generating a search script or model with a user agent, in accordance with the embodiments disclosed herein.

FIG. 11 illustrates a filter process, in accordance with the embodiments disclosed herein.

FIG. 12 illustrates a process of providing and querying the data model, in accordance with the embodiments disclosed herein.

FIG. 13 illustrates a computing component for providing micro code system, in accordance with the embodiments disclosed herein.

FIG. 14 is an example of a computing system that may be used in implementing various features of embodiments of the disclosed technology.

The figures are not exhaustive and do not limit the present disclosure to the precise form disclosed. It should be understood that the invention can be practiced with modification and alteration, and that the disclosed technology be limited only by the claims and the equivalents thereof.

### DETAILED DESCRIPTION

Web search engines and processes can be improved. One particular type of web search uses a search crawler tool called a stock screener, which can be employed by various users (e.g., traders, investors, etc.) to identify stocks and other information based on the user-defined and/or computer-defined metrics. For example, users can search for and filter stocks based on the market capitalization, price, price to earnings (P/E) ratio, 52-week price change percentage, dividend ratio, average five-year return on investment, average volume, and the like.

In some examples, the search crawler tool may generate one or more search queries for web information retrieval of data. These searches are complex and may require multiple searches from multiple resources. In some examples, these searches may require dynamic queries based on the results of previous search queries.

The development of a new search crawler tool is time consuming, due to creating customized queries and developing new filters to efficiently refine a search. Moreover, when the search crawler tool is deployed in operation, it can be slow due to numerous sequential interactions with various resources.

To reduce the development and tuning time for a new search crawler tool and to increase the execution performance of the search crawler tool, micro coding techniques may be introduced in improved computing systems and methods. For example, typical microcode may correspond with a processor design that provides a layer of computer organization between the processor (e.g., CPU, GPU) hardware and the Instruction Set Architecture (ISA) of the computer. For example, microcode may generally translate machine instructions, state machine data, or other input into sequences of detailed circuit-level operations. It also facilitates building complex multi-step instructions, while reducing the complexity of computer circuits, in order to achieve software compatibility between different products in a processor family.

Embodiments of the present disclosure may implement a second layer at the search engine computational technology stack to interact between the user agent and the ISA of the computer. Using somewhat similar theories of micro coding, the user agent at the user device may accept one or more of the components of an opcode, including an option, a query, a filter, a model, and/or a pointer. These components may be used to generate an instruction for the system. The system may dynamically organize these components into a search query (e.g., compile, schedule, etc.) and provide the search query to the new search crawler tool.

In some examples, the system may include a backend micro-code architecture and a front-end user agent. The user agent may accept an instruction that contains one or more components of an opcode, including an option, a query, a filter, a model, and a pointer. The backend system may receive the instruction and provide it to a bifurcated process. The first part of the process can decode the instruction and execute a series of search queries that correspond with the instruction (e.g., at the second layer). The second part of the process can receive the search results, create a data model/script that can be read by the user agent, and return/embed the data model/script to the user agent. The user agent may be enabled to search the data model locally at the user device to reduce the number of electronic communications between the backend and front-end. The user agent can enable the user to dynamically create a new search by selecting different combination of the five components of an opcode. The format for displaying the data may be based on a stored user profile.

Technical improvements are realized throughout this disclosure. For example, by incorporating micro-coding techniques, the system may dynamically schedule queries, concurrently execute queries, and/or receive or retain one or more stored queries to expedite prosecution and streamline program control. The proposed search crawler tool may be optimized for performance that leverages the speed of computational software development to rapidly create new search crawler tools.

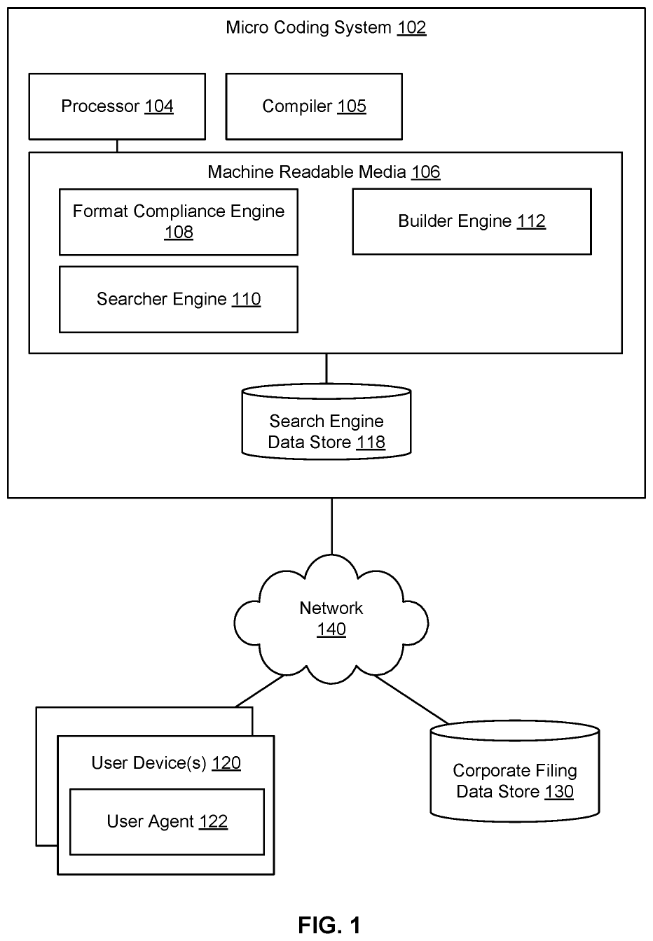

FIG. 1 illustrates a micro coding system, in accordance with the embodiments disclosed herein. For example, micro coding system 102 may comprise processor 104 capable of executing instructions, compiler 105, a machine readable media 106, format compliance engine 108, searcher engine 110, and builder engine 112 to dynamically construct programs based on the searching needs of the user.

Processor 104 may be one or more central processing units (CPUs), semiconductor-based microprocessors, and/or other hardware devices suitable for retrieval and execution of instructions stored in machine-readable storage medium 106. Processor 104 may fetch, decode, and execute instructions to control processes or operations for optimizing the system during run-time. As an alternative or in addition to retrieving and executing instructions, processor 104 may include one or more electronic circuits that include electronic components for performing the functionality of one or more instructions, such as a field programmable gate array (FPGA), application specific integrated circuit (ASIC), or other electronic circuits.

Compiler 105 can translate or compile one or more source files (e.g., containing the high-level language statements) into corresponding object files or modules. The object files can be combined into a program suitable for execution or running on a programmable computer.

Machine readable media 106 may be any electronic, magnetic, optical, or other physical storage device that contains or stores executable instructions. Thus, machine readable media 106 may be, for example, Random Access Memory (RAM), non-volatile RAM (NVRAM), an Electrically Erasable Programmable Read-Only Memory (EEPROM), a storage device, an optical disc, and the like. In some embodiments, machine-readable media 106 may be a non-transitory storage medium, where the term “non-transitory” does not encompass transitory propagating signals.

Format compliance engine 108 may receive an instruction from user agent 122 (via API and network 140). The instruction may contain one or more components of an opcode, including an option, a query, a filter, a model, and a next/pointer. Format compliance engine 108 may be configured to transform a search query into a search instruction.

In some examples, format compliance engine 108 may correspond with an abstraction processing layer of micro coding system 102. The layer may help achieve dynamic queries, dynamic query scheduling, concurrent execution, and/or enable machine learning to automatically create new arrangements. The constructs of this layer may comprise opcodes, special variables, special tokens, embedded tags (e.g., instructions), and localization or opcodes.

Opcodes may enable dynamic combination of instructions. The query language may contain atomic units. Each atomic unit may be a standalone component of a search query.

Special variables may enable dynamic query scheduling and concurrent execution. Each query may contain one or more key value pairs (KVP). The value can be parameterized at runtime. The key can deterministically define dependencies and thus be used by an execution scheduler.

Special Tokens may enable dynamic filters generation and machine learning assisted dynamic filter injection. Special tokens may correspond with the name of the encoded instruction. The results of a query may include summary data (e.g., aggregations) about the search results in the form of metrics, statistics, or other analytics. The query language may allow each summary datum to be tokenized. In some examples, the smart token may be a portable device that does special-purpose operations for its user (e.g., identify the filter display and specifications, etc.) that can be interpreted to create a filter from each summary datum.

Embedded Tags (e.g., instructions) may enable rapid deployment of a new screener application. The embedded tags may be utilized by the web application to inject features into online services. The embedded tags may abstract underlying technology from the user agent.

Localization of opcodes may enable rapid development of new queries or tuning of existing queries. The query language may be an underlying component of the search engine technology and not traditionally accessible to non-programmers. Exposing the individual opcode text files may enable non-programmers to have direct access to create and tune queries.

In some examples, format compliance engine 108 may determine whether a search query from user agent 122 corresponds with a fixed number of opcodes (e.g. somewhat similar to a RISC instruction set, etc.) and/or components of an opcode (e.g., operands, etc.) prior to transforming the search query to the search instruction. The components of the search query may define the query type and program control, and may be interchangeable to enable an unlimited number of combinations.

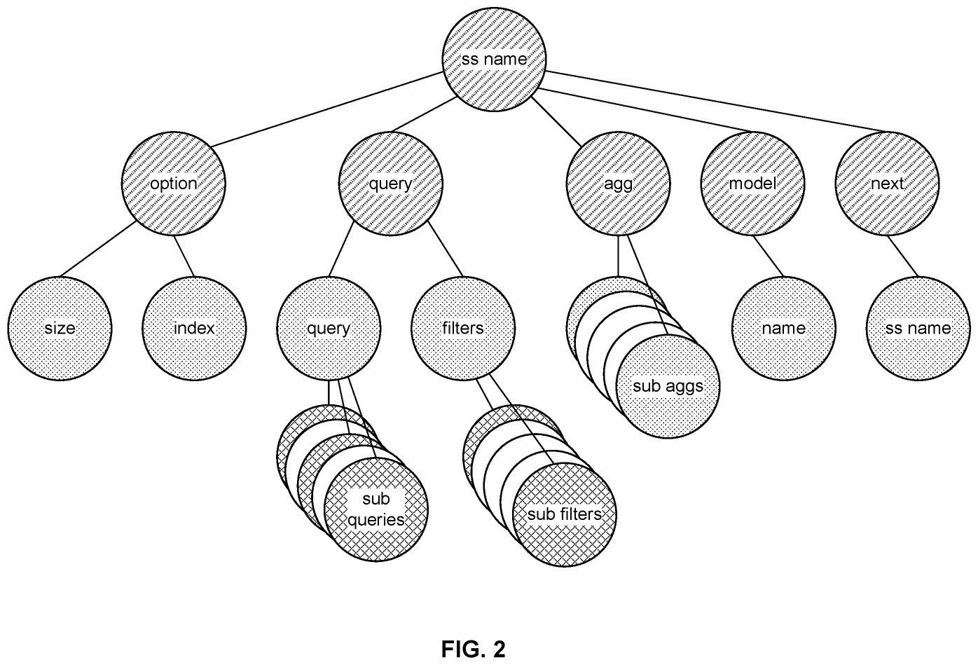

Illustrative components of the search query (e.g., opcode) are illustrated in FIG. 2 in the form of an abstract syntax tree (AST). The abstract syntax tree (AST) may illustrate a microcode instruction in multiple abstraction layers.

The top layer of the AST may correspond with the instruction, labeled “ss name” in FIG. 2. The top layer may be a short description or title corresponding with the instruction that is unique and stored with search engine data store 118.

The second layer of the AST may correspond with the opcodes. This layer may enable the ability to rapidly create new instructions through the recombination of existing opcodes. The second layer may also enable some performance controls (e.g., configuring results, etc.) to be cached. This may be advantageous over expansive filters that typically examine the entire index during a time consuming and operationally intensive task.

Each opcode may be annotated with metadata describing the behaviors of the opcode to assist a screener user on their development.

The opcodes may reside within the body property of the JavaScript Object Notation (JSON) structure. The instruction second layer may define each opcode as a name and may also include some control properties for the ISA processor. For example, the agg opcode may inform the ISA processor to cache the results.

The third layer of the AST may correspond with individual opcodes. The implementation of the individual opcodes can represent a design choice and may vary by implementation. In the micro coding paradigm, the opcode implementation can offer the opportunity to create an additional layer of simplicity between the web application instruction and the language of the underlying search engine. In some examples, when the language of the underlying search engine is complex, the opcode could be designed to create a new and less complex intermediate language.

The additional layer for additional simplicity may not require a new intermediate language because the language of the underlying search engine is simple and easily understood to an individual user. In some examples, the language does require the addition of special variables and tokens.

The opcode may be implemented in the language of the underlying search engine (e.g., Query DSL, etc.). The special variables may be embedded in the underlying search engine code to enable the compiler in ISA processor to perform data type checking and to inject user agent data into the underlying search engine code. The special tokens enable each filter to be represented as an atomic which underpins the ISA processor ability to create dynamic filters, inject dynamic filters into the underlying search engine code, and store usage data to train machine learning techniques.

Special tokens may be used to tag aggregations returned with search results. The tokens may inform the Builder how to create dynamic filters. In some examples, the token may have a grammar of a single statement made up of two variables.

Returning to the second layer of the AST, the components of the opcode may be limited to a particular format and number. For example, each opcode may include an option, a query, an aggregation filter, a model, and a pointer to the next instruction. The search data and search results may correspond with data from corporate filing data store 130 (e.g., financial data, corporate entity information that is filed with the Securities and Exchange Commission (SEC), etc.).

The option may comprise a size and index. The option may define the target index, the number of results to return, data to exclude, and/or pagination.

The query may include a query (with one or more subqueries) and one or more filters (with one or more sub filters). The query may be received from user device 120.

The aggregation filter may include one or more sub-aggregation processes. The aggregation filter may define the filters to apply to search returned from the query.

The model may include a model name corresponding with a model type. The model may define one or more types of display results and associated filters requested by user agent 122 and particular data that may be included in the resultant data model.

The pointer may include a name and/or a pointer to the next instruction. The pointer may define the next script to execute. In some examples, the next/pointer may identify the next script in a queue and provide the query to the user at a user interface. The user interface may include one or more characteristics that may be applicable for the data set and the user may respond by selecting one or more characteristics that they are interested in to execute with the next script. In some examples, these or other characteristics may be dynamically generated.

Once the search query and/or components are received from user agent 122, format compliance engine 108 may interrogate the data set to determine characteristics. The data set may be stored in search engine data store 118. If characteristics are true in the data set, a particular filter may be applicable and may be included as a potential option that can be chosen by the user at the user agent 122 to filter the data from the data model. Using filters, the data set provided in the data model may be expanded or reduced.

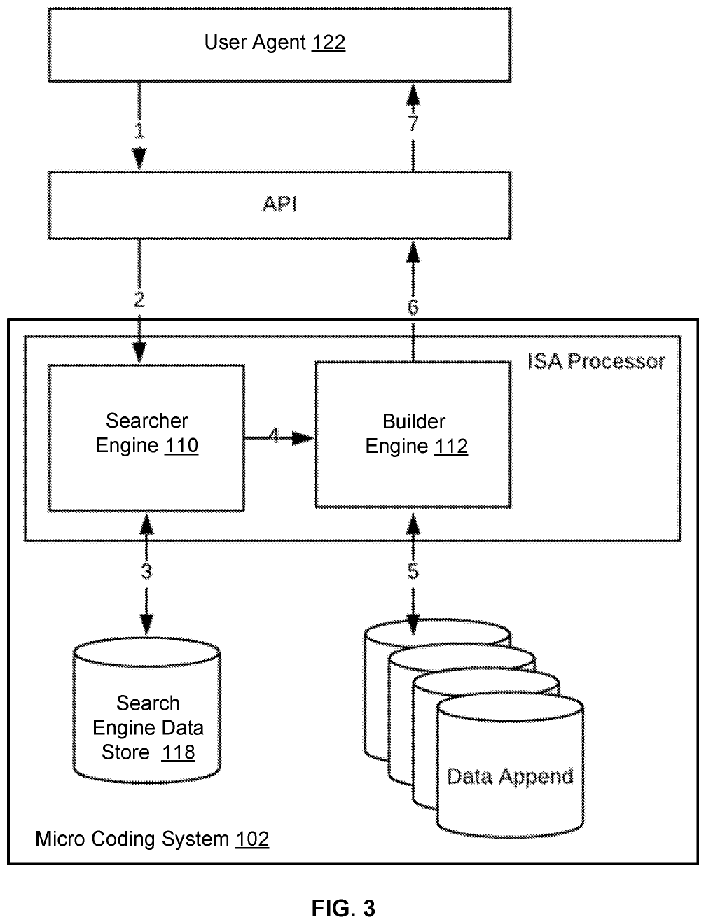

Format compliance engine 108 may provide the instruction to the bifurcated process as illustrated in FIG. 3. Micro coding system 102 of FIG. 1 may implement the bifurcated process.

At block 1, user agent 122 transmit the search query and/or components to API.

At block 2, API may transmit the search query and/or components to micro coding system 102.

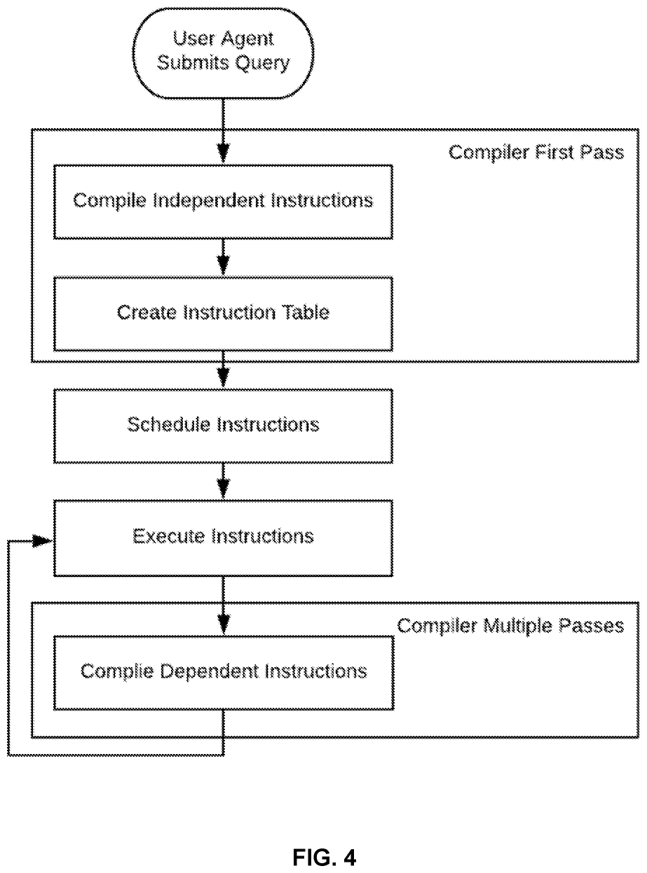

At block 3, searcher engine 110 may initiate the bifurcated process. The first part of the process can decode the search query and initiate a compiler to determine a series of independent instructions that correspond with the search query. Additional information is provided in FIG. 4.

The bifurcated process may be executed by searcher engine 110 and builder engine 112. For example, searcher engine 110 may be configured to receive a first search instruction, decode the search instruction, construct the search query using the opcodes and components that the searcher engine can execute, submit the search query to a searcher engine, and if the search instruction includes a pointer, fetch the next instruction. The steps may be repeated until all search instructions from user agent 122 are executed.

Search engine data store 118 may comprise one or more illustrative search instructions and one or more components that correspond with each search instruction. A query submitted to search engine data store 118 may return the one or more components. The components may include, for example, model: CompanyModelBuilder, option: opt_index_cm, query: query_term_cik_match, aggregation (“agg”): agg_statistics_filters, and/or next: ss_facet_match_all. An illustrative search query to search engine data store 118 may match all companies then apply a filter using the “and” operation for each filter.

```
“MatchCompanyInvestorSymbol”: {
  “body”: {
    “resultsBuilder”: “CompanyModelBuilder”,
    “option”: “opt_index_cm”,
    “query”: {
      “name”:
      “query_match_all_filtered_company_no_investor_agg”
    },
    “agg”: {
      “name”: “agg_statistics_filters”,
      “isCached”: “true”
    },
    “next”: “ss_facet_match_all”
  }
}
```

The “option” component may help define the source of the data. If needed, the data can originate from many locations to assist in parallel execution of the instructions. In some examples, the option may help search a company model index with trend maps. An illustrative option call may comprise the following:

```
“opt_index_cm”: {
  “body”: {
    “index”: “cm_arrays_prod”
  }
}
```

The “query” component may be exposed as a text string (e.g. JSON formatted, etc.). The text format may allow for rapid development of queries. A query call may comprise the following:

```
“query_match_all_filtered_company_no_investor_agg”: {
    “body”: {
      “query”: {
        “bool”: {
          “must_not”: {
            “term”: {
              “hasIncomingInvestments”: “false”
            }
          },
          “filter”: [
            {
              “bool”: {
                “must”: “QUERY_JSON_filter”
              }
            }
          ]
        }
      }
    }
  },
```

The “aggregation” component may be configured to summarize the search results (e.g., using expansive and reductive filters, etc.). Each aggregation may include a special token which corresponds with an encoded instruction that may be compiled by builder engine 112. The compilation may convert the encoded instruction into an executable instruction that is ultimately used by the display engine at user device 120 to present an option for user agent 122 to consume the data.

```
“agg_statistics_filters”: {
  “modelBuilder”: “StatisticsAndFiltersModelBuilder”,
  “body”: {
    “aggs”: {
      “SECTOR_MATCH_ALL_AGG_BUCKETS_KEY”: {
        “terms”: {
          “field”: “sicDescArray.keyword”,
          “size”: 500
        }
      },
      “CITIES_MATCH_ALL_AGG_BUCKETS_KEY”: {
        “terms”: {
          “field”: “mailingCity.keyword”,
          “size”: 25
        }
      },
```

The “next” component may be configured to provide the next instructions and/or a pointer. For example, the next component may be assigned a value that represents an instruction that enters the machine readable instructions (e.g., instructions set architecture (ISA), etc.). The assignment of the value may repeat until the instruction does not include a next value.

```
“match_all_investments”: {
  “body”: {
    “resultsBuilder”: “CompanyModelBuilder”,
    “option”: “opt_size_0_index_im”,
    “query”: {
      “name”: “query_match_all_agg”
    },
    “agg”: {
      “name”: “agg_statistics_filters_investments”,
      “isCached”: “true”
    }
  }
}
```

An illustrative compiler process with a scheduler is provided in FIG. 4. For example, the system receives a search query from user agent 122 and initiates a compiler first pass. During the compiler first pass, the system may compile independent instructions and create an instruction table. The instructions may be scheduled and executed. Then a second and subsequent pass may be initiated. During the subsequent pass, the system may compile dependent instructions.

In some examples, the pre-processor may convert an instruction to a single abstract syntax tree by looking up and combining all the opcodes of each instruction.

In some examples, the web screener apps may start with a lead instruction and/or one or more dynamic filters. The filters may be submitted as a parameter by the user agent (e.g., in the form of a JSON structure, etc.). The parameter may be recursively submitted to the pre-processor until all filter instructions are converted into their respective abstract syntax tree. The individual abstract syntax trees may be combined into one abstract syntax tree.

In some examples, the pre-processor may perform lookups on the instruction and then on the individual opcodes. The pre-processor may combine all opcodes of the instruction into one abstract syntax tree. The pre-processor may parse a filter factory array to extract each filter. The pre-processor may repeat these steps on each filter. For example, the pre-processor may extract the opcodes for filter instruction and then extract the associated data values for each filter. This can allow the compiler to inject that data into the various opcodes.

In some examples, the pre-processor can parse one or more filter options that are submitted by the user agent. This can help the system determine the logic expression to construct by applying logical (e.g., Boolean) operators to the individual filters.

After the pre-processor is complete, the abstract syntax tree may be traversed and all the special variables may be captured. As a sample illustration, the Lexical analyzer looks for a prefix=“QUERY_PARAMETER_<variable>” or “QUERY_JSON_<variable>” and strips the prefix, which can leave the name of the variable (e.g., referred to as a “key”).

In some examples, the query may be dependent on the results of another query. The semantic analyzer may be aware of the notion of independence. A variable may be considered independent when its data is provided by the user agent. In some examples, the independent variables that are not matched at the end of the semantic phase may result in an error.

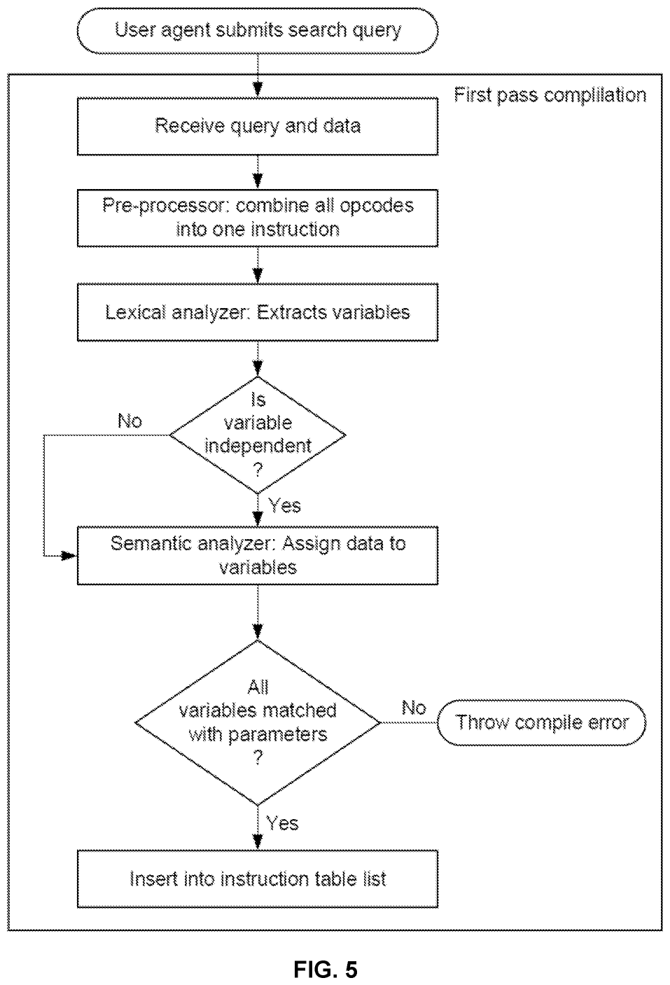

FIG. 5 illustrates a first pass compiler. For example, the compiler first pass may capture all independent and dependent instructions to create an instruction table. When utilizing the “next” opcode, these instructions can be linked together to form a linked list.

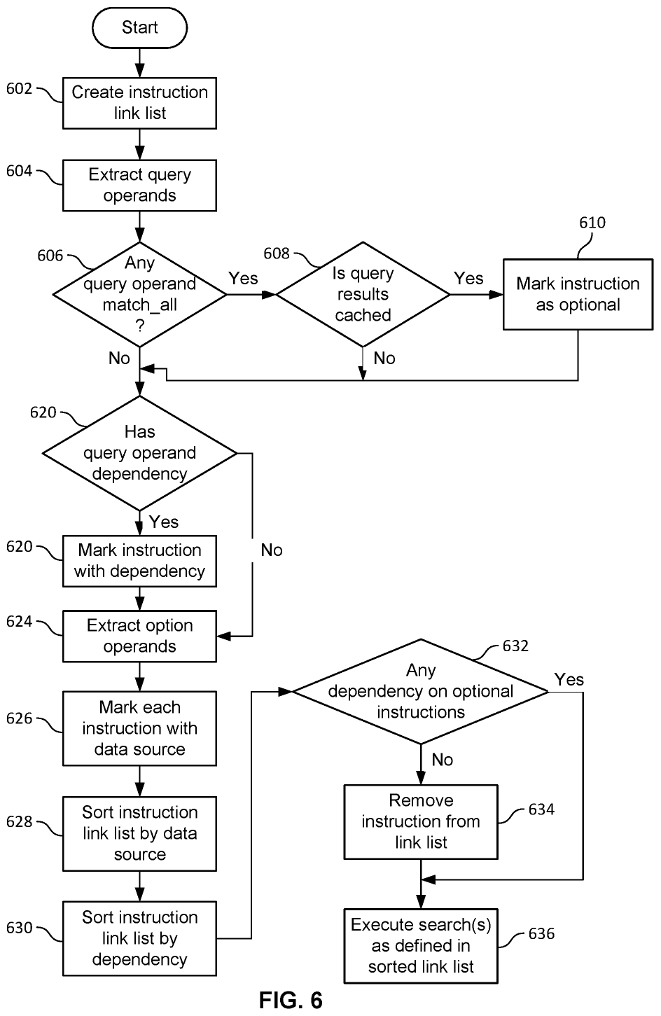

As illustrated, the system receives a search query from user agent 122 and initiates a compiler first pass. During the compiler first pass, the system may receive the query and data, initiate the pre-processor steps described herein to combine opcodes into one instruction, and extract the variables. The semantic analyzer may assign data to the variables and determine if all variables are matched with parameters. If yes, the variables may be inserted into the instruction table list, as illustrated in FIG. 6. If not, a compile error may be thrown/activated.

In an illustrative example, a screener designer user wants to search publicly traded companies in a specific industry and then is interested in identifying the investors who invested in these public companies. The screener designer user may acknowledge that the user may not be satisfied with the search results and thus includes in the screener design expansive filters. The screener designer user may develop a plurality of instructions which correspond with a screener application, as illustrated herein:

| Sequence | Instruction | Description |
|---|---|---|
| 1. | ss_disMaxFuzzOnAnySubjectCompany | The search captures subject companies (e.g., publicly |
| | | traded companies) |
| 2. | ss_filters_match_all_companies | The search creates expansive filters applicable to ALL |
| | | subject companies in the index |
| 3. | ss_disMaxFuzzOnAnyFiledByCompany | The search captures filed by companies (e.g., investors) |
| | | known to have invested in the subject companies |
| | | discovered in the first search |
| 4. | ss_filters_match_all_investors | The search creates expansive filters applicable to ALL |
| | | filed by companies in the index |

In the instruction table, truncated instructions (e.g., showing only the “next” opcode for illustration) may correspond with the following as they appear in the pre-processor phase.

```
  instruction 1: ss_disMaxFuzzOnAnySubjectCompany =
        {
          ...
        “next”: “ss_filters_match_all_companies”
    }
  Instruction 2: ss_filters_match_all_companies =
    {
      ....
      “next”: “ss_disMaxFuzzOnAnyFiledByCompany”
    }
  Instruction 3: ss_disMaxFuzzOnAnyFiledByCompany =
    {
      ....
      “next”: “ss_filters_match_all_investors”
    }
  Instruction 4: ss_filters_match_all_investors =
    {
      ....
      “next”: “ ”
    }
```

The “Next” opcode in the fourth instruction may be empty to instruct the ISA processor that the program is complete. In some examples, the complete list of instructions corresponds with a computer program and is represented as the instruction table. The instruction table can define the instructions and the order of execution. The first pass of the compiler can populate the instruction table because the instructions may be sequenced in the order of discovery.

FIG. 6 illustrates searching using an instruction linked list.

At block 602, an instruction link list may be created.

At block 604, query operands may be extracted.

At block 606, a determination is made if any query operands match. If yes, the process may proceed to block 608. If no, the process may proceed to block 620.

At block 608, a determination is made if the query results are cached. If yes, the process may proceed to block 610. If no, the process may proceed to block 620.

At block 610, the instruction may be marked as optional.

At block 620, a determination is made if any query operand is dependent. If yes, the process may proceed to block 622. If no, the process may proceed to block 624.

At block 622, the instruction may be marked as dependent.

At block 624, the option operands may be extracted.

At block 626, each instruction may be marked with the data source.

At block 628, each instruction link list may be sorted by the data source.

At block 630, each instruction link list may be sorted by the dependency.

At block 632, a determination is made if there exist dependencies on optional instructions. If yes, the process may proceed to block 636. If no, the process may proceed to block 634.

At block 634, the instruction may be removed from the link list.

At block 636, the search(es) may be executed as defined in the sorted link list.

Returning to FIG. 1, searcher engine 110 may comprise a search crawler tool may be used with an indexer tool to determine the search results. The indexer tool may store information to improve the correlation between search query and search results.

The indexer tool may implement an inverted index. The inverted index may include a database index that stores a mapping from content, such as words or numbers, to its locations in an entity filing document (e.g., via a Securities and Exchange Commission (SEC) filing, etc.), in a translated document, or in a set of documents.

In some examples, the stored information is used to generate an instruction in a predetermined format to aid in both document discovery and document relevance scoring in a search. The indexer may identify and/or acquire raw data from various sources and normalize it to enable an indexer to store correctly.

Returning to FIG. 3 at block 4, builder engine 112 may be configured to implement the second part of the bifurcated process. The second part of the process can receive the search results, create a data model/script that can be read by the user agent 122, and return/embed the data model/script to the user agent 122.

For example, builder engine 112 may be configured to receive the search results back from web page that provides the searcher engine, create a data model of the search results, and dynamically create new search instructions targeting the search results.

At block 6, builder engine 112 may return the search results model and instructions back to the API.

At block 7, API may return the search results model and instructions back to the web page for user agent 122. The web page may require a display engine for providing a varying set of data and mechanism to assemble one or more of the embedded instructions based on the user's interaction with the web page.

When used together, the search crawler tool and indexer tool may retrieve the most relevant documents using relevance scoring, query context, and filter context. The relevance score may define “how well the results matches the query?” The query context may define “How well does the results match the question posed by the user?” The filter context may define “How well does the results match the question?”

The relevance score may be computed using search results that are returned from searcher engine 110. The relevance score may be used to sort the results based on the underlying search engine's matching algorithm of the query to the document. In some examples, a ranking process may calculate a new score for each document and then implement a second sorting process on the documents (e.g., a re-sort).

The ranking and subsequent resorting may be executed as a last step of the results builder process. For example, any data appending may impact the relevancy of the documents and the ranking/re-sorting process may incorporate the additional data. The ranking process may correspond with a scoring equation to each document in the search results. The new score may be used to sort the results based on a sort parameter.

As an illustration, a common search request is to find investors who invest in a certain size of company and once found, the goal is to present the investor's contact information and with the most experience. In this case, the investors with a phone number, email, and number of years' experience are more relevant.

The query context may identify a type of search or response that can be incorporated with the re-sorting process, as discussed throughout the disclosure.

The filter context uses the agg opcode (from the searcher) and defines an aggregation to apply to the search results. In some examples, a typical aggregation in financial data is “cities” whereby the search engine counts the number of occurrences of each city appearing in the search results. The agg opcode may help serve an instruction to inform the ISA on how to build one or more filters to remove data (e.g., in a dynamic filtering context).

As an illustration, a search query is received for high tech companies in the USA. The filtering may identify the city, then the city aggregation would include counts for such cities as New York, San Francisco, Los Angeles, Chicago, etc. The search engine may return the results of the aggregations with a token.

The special token may correspond with a single statement made up of two variables, including “USER_AGENT” (defines how the user experience/interface displays and bundles the filters) and “INSTRUCTION” (name of a search instruction in a data store). Builder engine 112 may extract the token from the aggregation.

Searcher engine 110 and builder engine 112 may work together. For example, searcher engine 110 may decode the search instruction to determine one or more opcodes and/or components (e.g., ref fig Instruction Set Architecture: “Look search script”, “Parse script”). The decoding process may be implemented by first looking up the search instruction in search engine data store 118 on micro coding system 102 (e.g., in the form of a JSON file, etc.) and then decomposed into the one or more components. Each component may be retrieved from a look up file. The component can be rapidly adjusted (e.g., using the look up file) without expensive or time consuming software compiling.

Builder engine 112 may dynamically create new search instructions targeting the search results and return the search results model and instructions back to the web page (e.g., the search instructions may include “ref fig Instruction Set Architecture,” “Compile”, “Instruction script”, “Parameterize search queries,” etc.). The compilation may form a complete instruction understandable by searcher engine 110. This series of steps may combine the individual components and parameterize the structure based on the input.

Builder engine 112 may be configured to submit the search script (e.g., the search instructions may include “ref fig Instruction Set Architecture,” “Submit search”, “Bundle results,” etc.). The search script may be sent to the searcher engine. The searcher engine results may be returned to the user device 120 and the next search instruction may be sent when all the instructions are executed.

Builder engine 112 may be configured to examine the individual processes. Decomposing Searcher Instructions (e.g., the search instructions may include “ref fig Instruction set architecture,” “Parse search history,” “Get model factory,” “Build data models,” etc.). The search results may be packaged for consumption by the system responsible for displaying the results.

Builder engine 112 may be configured to embed filter instructions (e.g., the search instructions may include “ref fig Instruction set architecture,” “Parse agg results,” “Filters/Facets,” “Search Script Code Generator,” etc.). For example, the web retrieval of search results may include filters applicable the returned data. The aggregation component may define the filters and each filter may include an encoded name that may be decoded and converted into an instruction. In some examples, the aggregation-related instructions may include the opcode and components.

An illustrative call corresponding to an aggregation filter for “city” with the name “CITIES_MATCH_KEY” being encoded. If the search results return a value for a city, the encoded instruction may be compiled into an instruction with data. For example, the search results include a city of Los Angeles and the encoded instruction CITIES_MATCH_KEY is compiled into an instruction with data “LOS ANGELES.”

```
“CITIES_MATCH_KEY ”: {
      “terms”: {
        “field”: “mailingCity.keyword”,
        “size”: 25
      }
    }
{
  “filters”: [
    {
      “filterSpec”: {
        “title”: “Cities”,
        “text”: “ LOS ANGELES ”,
        “filterType”: “bucket”,
        “field”: “mailingCity.keyword”,
        “bucketValue”: “LOS ANGELES”, <======
        “count”: 1
      }
    }
  ]
}
```

Builder engine 112 may be configured to provide localization results (e.g., the search instructions may include “ref fig Instruction set architecture,” “localization results,” etc.). Each instruction may be localized to user device 120 (FIG. 1). The localization may enable the display to present the appropriate machine readable instructions to the user agent 122.

In some examples, the search engine returns the search results as the search instructions (e.g., in a JSON structure). For example, the ISA processor can bundle the search results with metadata which provides information about the search such as the executed instruction, parameters, and filters.

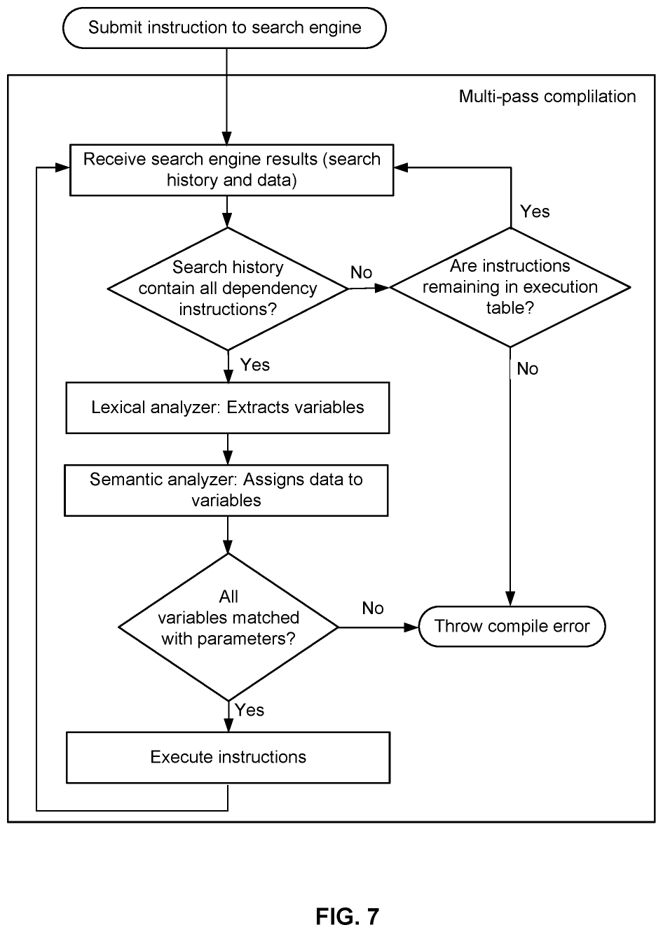

FIG. 7 illustrates a multi-pass compiler process. For example, the compilation of the search script may require a multi-pass compilation. This may be used when there exists variables that depend on the results of a search result.

The multi-pass compiler may be similar to the first pass compiler (illustrated in FIG. 5) except the data used to assign to variables comes from the search results. For example, the results of the first pass compilation is a set of instructions that are independent of each other and consequently are sent to the search engine. The multi-pass compilation may begin by submitting the unexecuted instructions in the execution table to the compiler.

As illustrated, the system receives the instruction from the search engine (e.g., associated with the first pass and/or the search query from user agent 122) and initiates a multi-pass compilation. The system may receive the search history and data and determine if the search history contains ALL dependency instructions. If yes, the process may extract the variables and the semantic analyzer may assign data to the variables. If all variables are matched with parameters, the instructions may be executed. If not, a compile error may be thrown/activated. If ALL dependency instructions are not received with the search history, the process may retrieve the instructions from the execution table. If instructions remain in the execution table, a compile error may be thrown/activated.

Micro coding techniques enable query scheduling. In the context of micro coding, scheduling refers the sequence of instruction execution. In the following example, two instructions are defined. The instruction processor notices that the ‘option’ parameter is using the same index and thus the processor has the flexibility to execute the two instruction in parallel.

In some examples, the instruction execution is determined by an instruction scheduler process. The scheduler may considers constraints from the query interdependencies and by the underlying technology deployment. For example, the scheduler may capture all the instructions associated with the initial instruction received from the user agent by using the Next opcode in each subsequent instruction. The scheduler may examine the operand of each query opcode. There may be several rules applied that provide each instruction a sequence number for execution. If all instructions have the same sequence number, then all instructions can run concurrently or in parallel. If instruction interdependence is observed, the instructions may be assigned different sequence execution numbers (e.g., if an instruction depends on the output of another instruction, the initial instruction may have an earlier sequence number than the dependent instruction). Upon the conclusion of the scheduler, each instruction may correspond with a unique sequence number.

During the multi-pass compilation, builder engine 112 may receive the search results back from searcher engine 110. Builder engine 112 can create a data model of the search results, dynamically create filters that target the search results, and return the search results model and instructions back to the web page for user agent 122.

An illustrative example of micro code for search by name for institutional investors is provided.

```
{
  “investor ”: {
    option: { index: institutional_investor },
    query: search_by_name
    filter: filter_for_institutional_investor
  }
}
```

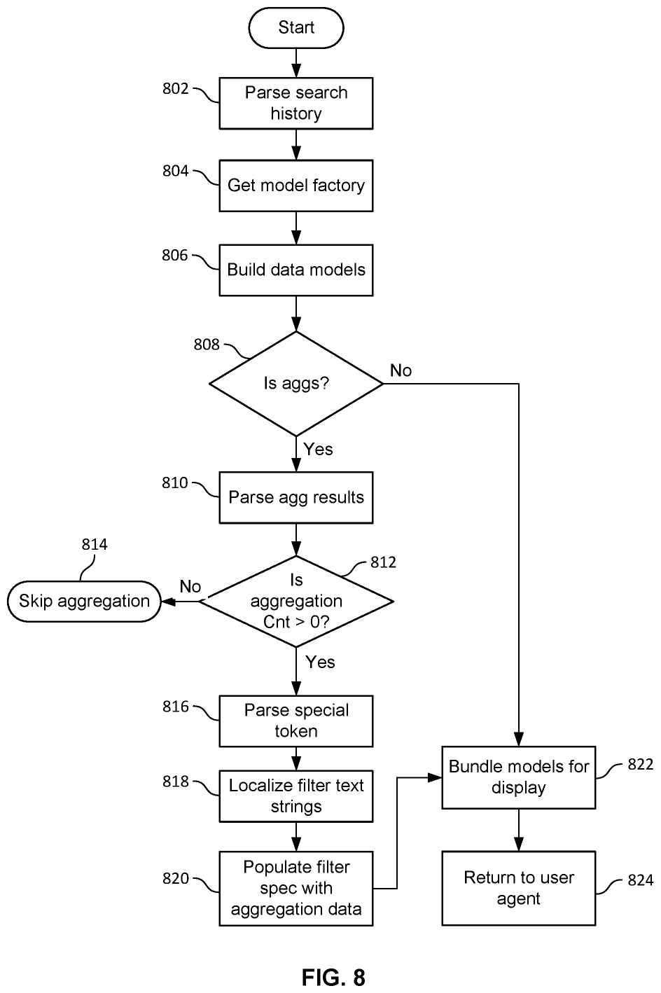

FIG. 8 illustrates a builder process for examining individual processes. For example, builder engine 112 may be implemented as two components, including a results builder and a filter builder.

The results builder may package the search results including any additional scoring, sorting, data appending, or data pruning. The packaging process may use the search results to generate each search instruction. The results builder can receive the search history from searcher engine 110 which may be parsed to extract the opcode called model for each instruction.

The filter builder may define how the aggregations are converted into statistics and filters. For example, the filter builder may access the agg opcode to define an aggregation to apply to the search results. An illustrative aggregation in financial data may comprise “cities” where the search engine counts the number of occurrences of each city appearing in the search results. An agg opcode to request an aggregation would look like the following.

At block 802, a search history may be parsed

At block 804, a model factory may be received or retrieved.

At block 806, one or more data models may be built.

At block 808, a determination is made if the data model corresponds with an agg opcode. If yes, the process may proceed to block 810. If no, the process may proceed to block 822.

At block 810, the agg results may be parsed.

At block 812, a determination is made if the aggregation count is greater than zero. If yes, the process may proceed to block 816. If no, the process may proceed to block 814.

At block 814, the aggregation may be skipped and the process ends.

At block 816, a special token (e.g., a smart token corresponding with the name of the encoded instruction) may be parsed.

At block 818, one or more filter text strings may be localized.

At block 820, a filter specification may be populated with aggregation data.

At block 822, one or more models may be bundled for display.

At block 824, one or more models may be returned to the user agent.

Returning to FIG. 1, user device 120 may be a computing device that one or more application-specific integrated circuits (ASICs) or field programmable gate arrays (FPGAs) that are programmed to perform various processes or methods described herein. User device 120 may combine custom hard-wired logic, ASICs, or FPGAs with custom programming to accomplish the techniques. User device 120 may be desktop computer system, server computer system, portable computer system, handheld device, networking device, or any other device or combination of devices that incorporate hard-wired and/or program logic to implement the processes or methods described herein.

User device 120 may comprise user agent 122. User agent 122 may be a standalone application at the user device 120 or embedded with a browser application at the user device 120. User agent 122 may include, for example, (1) a search bar to accept a search query, (2) a set of reductive or expansive filters, and (3) a set of results.

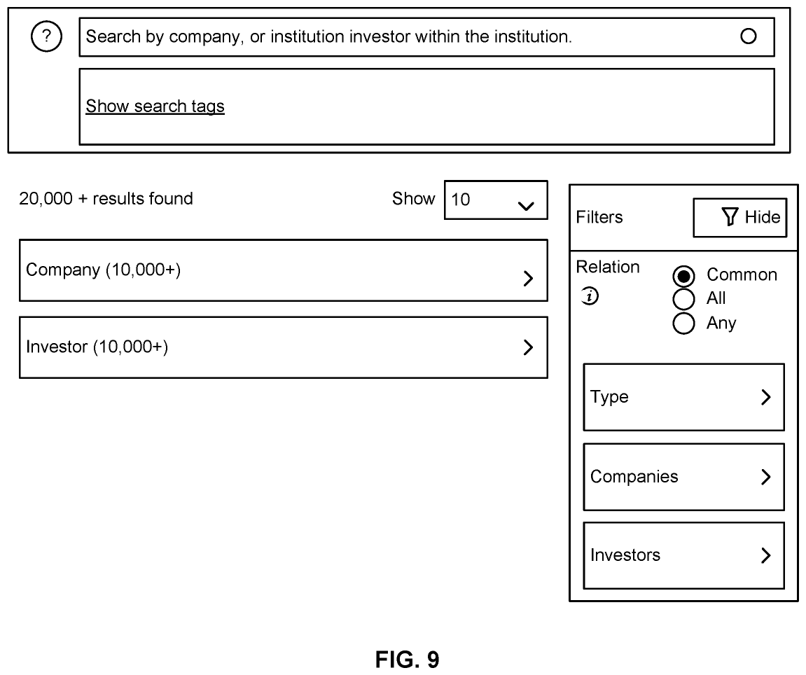

An illustrative user interface is provided in FIG. 9. The user interface may be configured to receive one or more components or parameters of a search query. The one or more parameters of a search query that may be translated to the search instructions. For example, the single parameter may use the HTTP syntax and provide micro coding system 102 with the query and the following illustrative search instruction:

```
{
  “queryParameters”: {
    “q”: “alpha”,
    “ss”: “find_CompanyInvestorSymbol”
  }
}
```

The search instruction may leverage the micro coding techniques. The search instruction may be sent from the browser of the user device (or user agent 122) to micro coding system 102. Micro coding system 102 may receive the search instruction and provide it to a micro code processor that may execute the search. Micro coding techniques may be used in the screener context to help identify and then abstract components of a search operation. The micro code may enable an easier and faster methodology with predetermined parameters in the search instruction.

The search instruction may be presented in a human readable format. The instruction may be implemented using JSON, although any programming language may be implemented without diverting from the essence of the disclosure.

An illustrative example is when a user agent implements two screeners, where a first screener is designed to search for registered investment advisors by name and the second screener is designed to search for institutional investors by name. Both screeners may be similar in many respects but differ in the fact that they can each consume data from a different source and each can have different filters.

```
{
  “advisor”: {
    option: { index: advisor},
    query: search_by_name
    filter: filter_for_registered_investment_advisor
  }
}
```

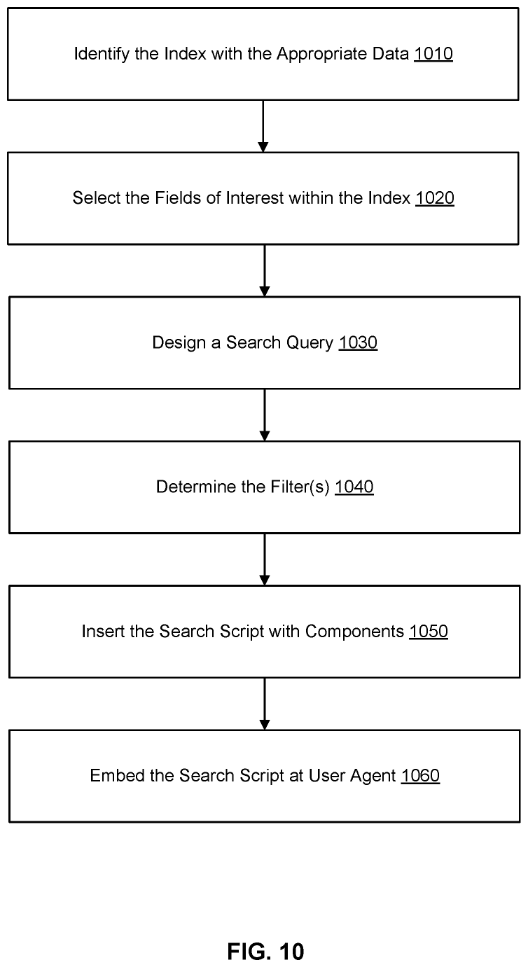

FIG. 10 illustrates a process for generating a search script or model with a user agent, in accordance with the embodiments disclosed herein. Micro coding system 102 may generate or develop a stock screener.

At block 1010, micro coding system 102 may identify the index with the appropriate data.

At block 1020, micro coding system 102 may select the fields of interest within the index.

At block 1030, micro coding system 102 may design a search query. The search query may leverage any of the supported search techniques and/or store the resultant search instruction (e.g., in a JSON format) in a query data model store.

At block 1040, micro coding system 102 may determine one or more filters. The filters may ultimately assist a user in either expanding a search or refining the search and store the search instruction (e.g., in a JSON format) in an aggregate data model store.

At block 1050, micro coding system 102 may insert the search script identifying the components store in a search script data store.

At block 1060, micro coding system 102 may embed the search script in user agent 122 for testing.

User agent 122 may receive a data model from micro coding system 102. For example, the search query may be translated to a search instruction at micro coding system 102 and micro coding system 102 can provide a data model back to user agent 122 that corresponds with the original search query. In some examples, the data model may be limited to financial data.

User agent 122 may be enabled to search the data model locally at the user device to reduce the number of electronic communications between the backend (micro coding system 102) and front-end (user device 120). User agent 122 can enable the user to dynamically create a new search by selecting different combination of the five components.

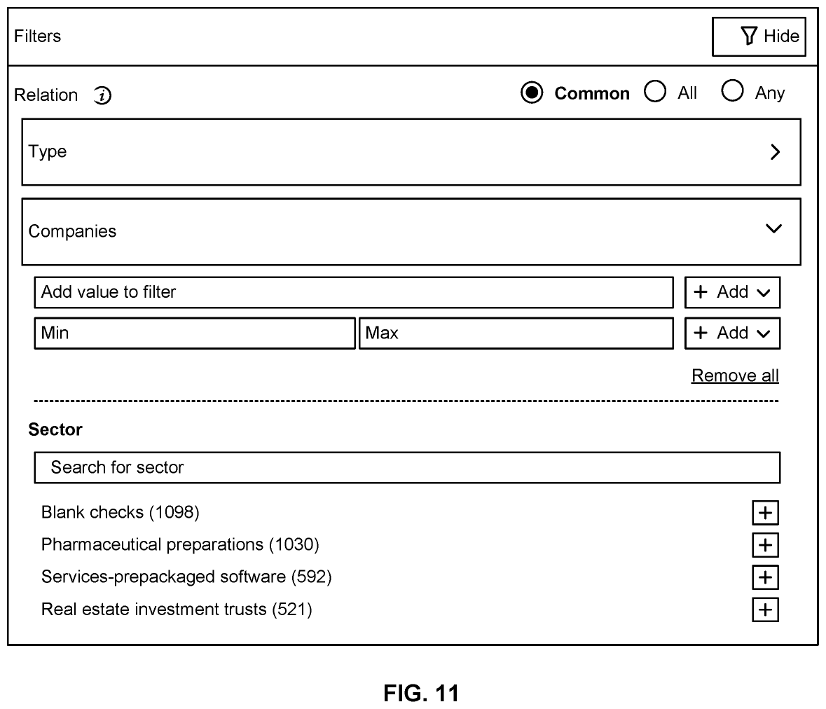

At illustrative filtering user interface is provided with FIG. 11. For example, when micro coding system 102 provides the data model, the data model may include a listing of data generated from the search instruction without filters applied (e.g., “AND” or “OR” etc.). User agent 122 can display the results and choose how to apply the filters.

Various filters may be applied, including an aggregation filter. The aggregation filter may implement one or more aggregation scripts to enable dynamic identification of various statistics and filters related to the user's search. One or more filters may be implemented that are related to a product. The filters may dynamically appear in the form of facets (e.g., price range, sizes, colors, etc.).

The filters may not be standardized and may be determined after a discovery phase. The filter discovery phase may include an identification of filters using an aggregation filter script. This may eliminate the need for transmitting updated code to user agent 122 when a new filter is created or updated.

The filter types may include expanding filters, reductive filters, or analytical filters. Expanding filters may include aggregations applied to either the search results or to the entire index to present alternative searches. Reductive filters may include aggregations applied to either the search results or to the entire index the search results to narrow choices. Analytical filters may include aggregations applied to either the search results or to the entire index a single company filter to provide useful analytics.

The format for displaying the data from data model at user device 120 may be based on a stored user profile. The user profile may be stored locally at user device 120 (e.g., as a parameter in user agent 122) or at search engine data store 118 of micro coding system 102.

In some examples, an aggregation script may define the filters from FIG. 6 to generate the search results. The aggregation script may provide the specifications to the user interface on how to display aggregation results and how to build the facets in the form of links. Each aggregation script structure may leverage the elasticsearch QueryDSL structure for aggregations. An application programming interface (API) may support aggregation families, including bucketing and metrics collection.

For example, user agent 122 may construct a complex object by specifying the type and content only. The components may be transferred to builder engine 112 of FIG. 1 via network 140. The construction details may be hidden from the user entirely. The user can still direct the steps taken by builder engine 112 without knowing how the actual work is accomplished. Builder engine 112 may encapsulate construction of various objects.

In some examples, the API may help define a data structure format for a templated version of the query format. The data may be dynamically replaced to enable a real-time substitution of components of the opcode. The components can be applied to the query body before the execution of the search function. The associated key may be a customizable string which is encoded, and when the search query is parsed, the components can help define the user display of the search results.

In some examples, bucketing may be implemented. For example, the bucketing process may include a family of aggregations that build buckets, where each bucket is associated with a key and a document criterion. When the aggregation is executed, the bucket criteria may be evaluated on each document in the context. When a criterion matches, the document may be considered to correlate to the relevant bucket. By the end of the aggregation process, a list of populated buckets may be stored with the system, where each bucket includes a set of documents that correspond with it. In some examples, an associated key is used to retrieve the document results.

In some examples, micro coding techniques enable software as a service (SaaS) functionalities. For example, SaaS may define a concept in which product and services can be built on top of an API. As described above, the user agent requires a single parameter to engage a specific screener search. The backend configures the screen search by constructing scripts. All of the actions can be accessible via an API because the micro identifies the five common components for the implementation of any screener. The component are then exposed to a screener designer who can develop new screeners by creating new JSON snippets for any of the five components and then assigning an initial instruction in the search script model store which is what used by the user agent.

As an illustrative example, a company desires to create a search screener to identify a specific registered investment advisor. The screener is required to find the prospective advisors by name and shall allow refinement of the search using filters based on advisor's location and certifications.

The aggregations may also keep track and compute metrics over a set of documents. The aggregations may be stored with search engine data store 118.

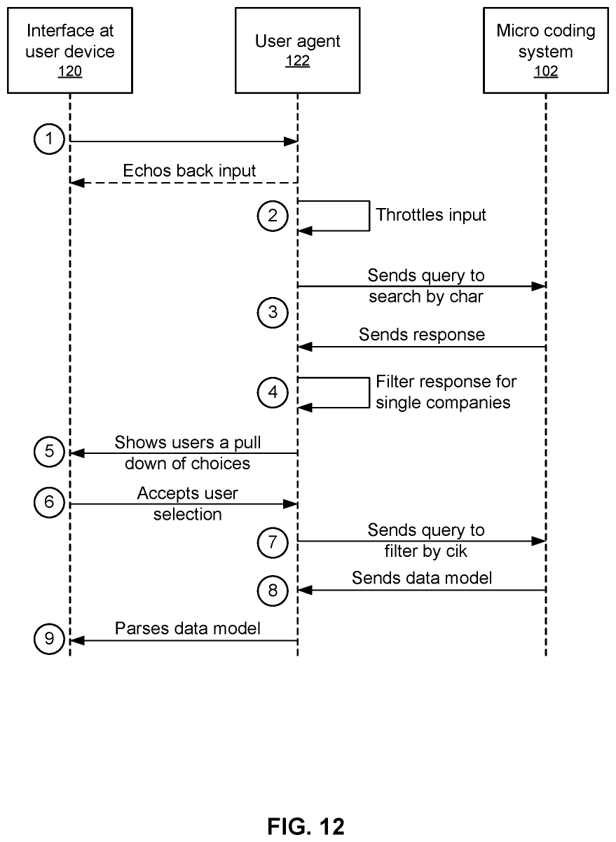

FIG. 12 illustrates a process of providing and querying the data model, in accordance with the embodiments disclosed herein. The process may be implemented between the interface at user device 120, user agent 122, and micro coding system 102.

At block 1, the interface at interface at user device 120 may provide the search query to the user agent 122. User agent 122 may echo back the input to the interface.

At block 2, user agent 122 may throttle the input.

At block 3, user agent 122 may transmit the input/search query to micro coding system 102. Micro coding system 102 may transmit a response back to user agent 122.

At block 4, user agent 122 may filter the response. The filter may be implemented for single entities to expand or reduce the data set returned by micro coding system 102.

At block 5, user agent 122 may provide the filtered search results to the interface of the user device 120. The filtered search results may be provided with one or more tools, including a list of options for interacting with the data (e.g., a pull-down list of options, etc.).

At block 6, the user may interact with the user interface at user device 120 to accept the user selection. User agent 122 may receive the user selection and use it to determine one or more components of the search query. In some examples, additional information may be added to the search query based on a user profile stored with search engine data store 118.

At block 7, user agent 122 may transmit the generated search query to micro coding system 102. Micro coding system 102 may implement the bifurcated process using searcher engine 110 and builder engine 112 to generate the data model, as described herein.

At block 8, micro coding system 102 may transmit the data model to user agent 122.

At block 9, user agent 122 may parse or otherwise process the data model at user device 120. The interface at user device 120 may display the data model for the user as search results tuned to respond to the user's search query (e.g., filtered or unfiltered, altered by ML model, etc.).

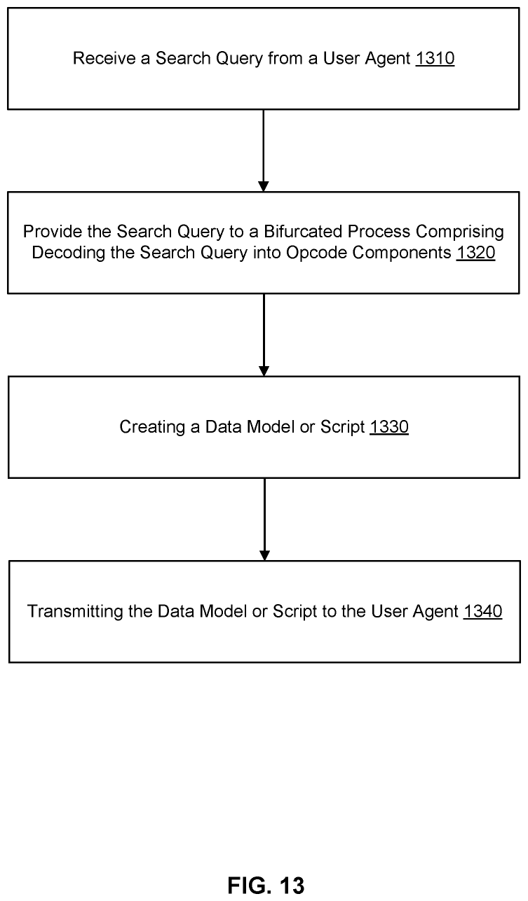

FIG. 13 provides an illustrative process, in accordance with the embodiments disclosed herein. The illustrative process may be executed by processor 104 of micro coding system 102 of FIG. 1.

At 1310, a search query may be received from a user agent. For example, micro coding system 102 may receive a search query from a user agent. The search query may comprise one or more components of an opcode.

At 1320, the search query may be provided to a bifurcated process. For example, micro coding system 102 may provide the search query to a bifurcated process. In some examples, the bifurcated process comprises decoding the search query to generate a set of components; generating a search instruction using the set of components; executing the search instruction; and receiving search results from the search instruction.

At 1330, a data model or script may be created.

At 1340, the data model or script may be transmitted to the user agent. For example, micro coding system 102 may transmit the data model or script to the user agent. The data model may be embedded with the user agent.

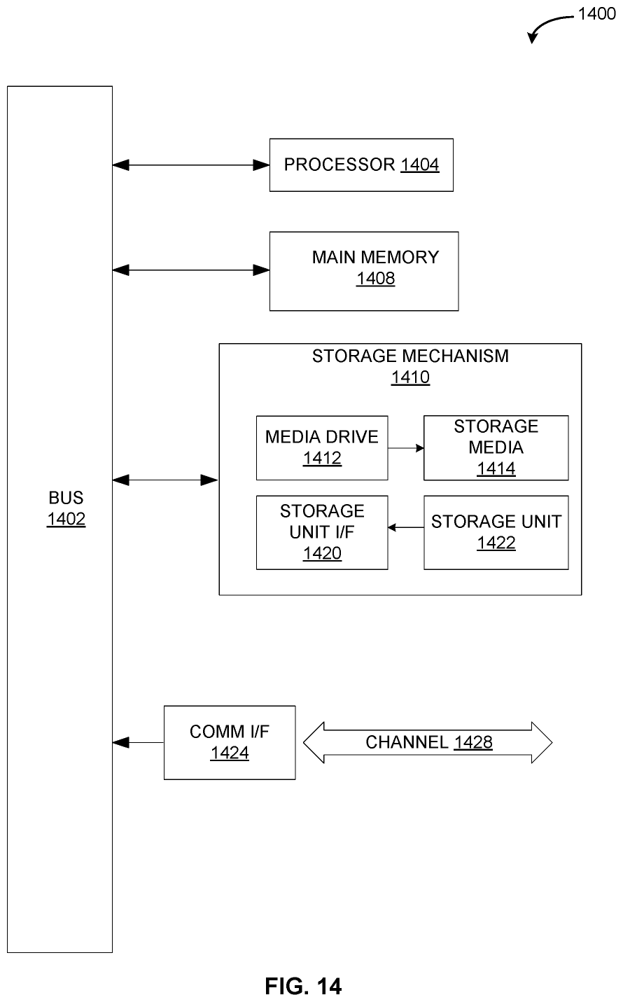

In some examples, the user agent is enabled to dynamically create a new search by selecting combinations of the one or more components of the opcode.

Where components, logical circuits, or engines of the technology are implemented in whole or in part using software, in one embodiment, these software elements can be implemented to operate with a computing or logical circuit capable of carrying out the functionality described with respect thereto. One such example logical circuit is shown in FIG. 14. Various embodiments are described in terms of this example logical circuit 1400. After reading this description, it will become apparent to a person skilled in the relevant art how to implement the technology using other logical circuits or architectures.

Referring now to FIG. 14, computing system 1400 may represent, for example, computing or processing capabilities found within desktop, laptop, and notebook computers; hand-held computing devices (PDA's, smart phones, cell phones, palmtops, etc.); mainframes, supercomputers, workstations, or servers; or any other type of special-purpose or general-purpose computing devices as may be desirable or appropriate for a given application or environment. Logical circuit 1400 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 1400 might include, for example, one or more processors, controllers, control engines, or other processing devices, such as a processor 1404. Processor 1404 might be implemented using a general-purpose or special-purpose processing engine such as, for example, a microprocessor, controller, or other control logic. In the illustrated example, processor 1404 is connected to a bus 1402, although any communication medium can be used to facilitate interaction with other components of logical circuit 1400 or to communicate externally.

Computing system 1400 might also include one or more memory engines, simply referred to herein as main memory 1408. For example, preferably random-access memory (RAM) or other dynamic memory, might be used for storing information and instructions to be executed by processor 1404. Main memory 1408 might also be used for storing temporary variables or other intermediate information during execution of instructions to be executed by processor 1404. Logical circuit 1400 might likewise include a read only memory (“ROM”) or other static storage device coupled to bus 1402 for storing static information and instructions for processor 1404.

The computing system 1400 might also include one or more various forms of information storage mechanism 1410, which might include, for example, a media drive 1412 and a storage unit interface 1420. The media drive 1412 might include a drive or other mechanism to support fixed or removable storage media 1414. For example, a hard disk drive, a floppy disk drive, a magnetic tape drive, an optical disk drive, a CD or DVD drive (R or RW), or other removable or fixed media drive might be provided. Accordingly, storage media 1414 might include, for example, a hard disk, a floppy disk, magnetic tape, cartridge, optical disk, a CD or DVD, or other fixed or removable medium that is read by, written to, or accessed by media drive 1412. As these examples illustrate, the storage media 1414 can include a computer usable storage medium having stored therein computer software or data.

In alternative embodiments, information storage mechanism 1440 might include other similar instrumentalities for allowing computer programs or other instructions or data to be loaded into logical circuit 1400. Such instrumentalities might include, for example, a fixed or removable storage unit 1422 and an interface 1420. Examples of such storage units 1422 and interfaces 1420 can include a program cartridge and cartridge interface, a removable memory (for example, a flash memory or other removable memory engine) and memory slot, a PCMCIA slot and card, and other fixed or removable storage units 1422 and interfaces 1420 that allow software and data to be transferred from the storage unit 1422 to logical circuit 1400.

Logical circuit 1400 might also include a communications interface 1424. Communications interface 1424 might be used to allow software and data to be transferred between logical circuit 1400 and external devices. Examples of communications interface 1424 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1424 might typically be carried on signals, which can be electronic, electromagnetic (which includes optical) or other signals capable of being exchanged by a given communications interface 1424. These signals might be provided to communications interface 1424 via a channel 1428. This channel 1428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1408, storage unit 1420, media 1414, and channel 1428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the logical circuit 1400 to perform features or functions of the disclosed technology as discussed herein.

Although FIG. 14 depicts a computer network, it is understood that the disclosure is not limited to operation with a computer network, but rather, the disclosure may be practiced in any suitable electronic device. Accordingly, the computer network depicted in FIG. 14 is for illustrative purposes only and thus is not meant to limit the disclosure in any respect.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
receiving a search query from a user agent, wherein the search query comprises one or more components of an opcode;
providing the search query to a bifurcated process, wherein the bifurcated process comprises:
decoding the search query to generate a set of components,
generating a search instruction using the set of components,
executing the search instruction, and
receiving search results from the search instruction;
creating a data model or script that is executed by the user agent; and
transmitting the data model or script to the user agent, wherein the data model is embedded with the user agent, and
wherein the user agent is enabled to dynamically create a new search by selecting combinations of the one or more components of the opcode.

2. The method of claim 1, wherein the bifurcated process further comprises:
determining a series of independent instructions that correspond with the search query.

3. The method of claim 2, wherein the series of independent instructions that correspond with the search query are scheduled and executed.

4. The method of claim 3, wherein the bifurcated process further comprises:
after receiving the search results from the search instruction, compiling the data model using the search results, wherein the search results are sorted using a relevance score.

5. The method of claim 4, wherein a builder engine embeds filter instructions in the data model.

6. The method of claim 1, wherein the search instruction is generated using a plurality of opcodes associated with the search query and annotated with metadata.

7. The method of claim 6, wherein each opcode in the plurality of opcodes comprises an option, a query, an aggregation filter, a model, and a pointer to a next opcode in the plurality of opcodes.

8. The method of claim 1, further comprising:
generating an abstract syntax tree (AST) to illustrate microcode instructions of the search instruction in multiple abstraction layers.

9. A computer system, comprising:
a memory; and
one or more processors that are coupled to the memory and configured to execute machine readable instructions stored in the memory for performing a method comprising:
receiving a search query from a user agent, wherein the search query comprises one or more components of an opcode;
providing the search query to a bifurcated process, wherein the bifurcated process comprises;
decoding the search query to generate a set of components;
generating a search instruction using the set of components;
executing the search instruction; and
receiving search results from the search instruction;
creating a data model or script that is executed by the user agent; and
transmitting the data model or script to the user agent, wherein the data model is embedded with the user agent, wherein the user agent is enabled to dynamically create a new search by selecting combinations of the one or more components of the opcode.

10. The system of claim 9, wherein the bifurcated process further comprises:
determining a series of independent instructions that correspond with the search query.

11. The system of claim 10, wherein the series of independent instructions that correspond with the search query are scheduled and executed.

12. The system of claim 9, wherein the bifurcated process further comprises:
after receiving the search results from the search instruction, compiling the data model using the search results, wherein the search results are sorted using a relevance score.

13. The system of claim 9, wherein a builder engine embeds filter instructions in the data model.

14. The system of claim 9, wherein the search instruction is generated using a plurality of opcodes associated with the search query and annotated with metadata.

15. The system of claim 14, wherein each opcode in the plurality of opcodes comprises an option, a query, an aggregation filter, a model, and a pointer to a next opcode in the plurality of opcodes.

16. The system of claim 9, further comprising:
generating an abstract syntax tree (AST) to illustrate microcode instructions of the search instruction in multiple abstraction layers.

17. A non-transitory computer-readable storage medium storing a plurality of instructions executable by one or more processors, the plurality of instructions when executed by the one or more processors cause the one or more processors to:
receive a search query from a user agent, wherein the search query comprises one or more components of an opcode;
provide the search query to a bifurcated process, wherein the bifurcated process comprises:
decoding the search query to generate a set of components;
generating a search instruction using the set of components;
executing the search instruction; and
receiving search results from the search instruction;
create a data model or script that is executed by the user agent;
transmit the data model or script to the user agent, wherein the data model is embedded with the user agent, wherein the user agent is enabled to dynamically create a new search by selecting combinations of the one or more components of the opcode; and
generate an abstract syntax tree (AST) to illustrate microcode instructions of the search instruction in multiple abstraction layers.

18. The non-transitory computer-readable storage medium of claim 17, wherein the bifurcated process further comprises:
determining a series of independent instructions that correspond with the search query, wherein the series of independent instructions that correspond with the search query are scheduled and executed; and
after receiving the search results from the search instruction, compiling the data model using the search results, wherein the search results are sorted using a relevance score.

19. The non-transitory computer-readable storage medium of claim 17, wherein a builder engine embeds filter instructions in the data model.

20. The non-transitory computer-readable storage medium of claim 17, wherein the search instruction is generated using a plurality of opcodes associated with the search query and annotated with metadata, each opcode in the plurality of opcodes comprises an option, a query, an aggregation filter, a model, and a pointer to a next opcode in the plurality of opcodes.
